(19) United States
(12) Patent Application Publication
(10) Pub. No.: US 2013/0265153 A1
(43) Pub. Date: Oct. 10, 2013

(54) APPARATUS AND METHOD FOR SHOCK OR IMPACT DETECTION IN MOVEMENT OF CARGO, OPERATION OF EQUIPMENT, AND OTHER ENVIRONMENTS

(71) Applicants: Brandon C. Taylor, Frisco, TX (US); Jason A. Wible, Plano, TX (US); James S. MacLean, III, Coppell, TX (US)

(72) Inventors: Brandon C. Taylor, Frisco, TX (US); Jason A. Wible, Plano, TX (US); James S. MacLean, III, Coppell, TX (US)

(73) Assignee: Geoforce, Inc., Lewisville, TX (US)

(21) Appl. No.: 13/443,819

(22) Filed: Apr. 10, 2012

(51) Int. Cl. G08B 21/18; G08B 1/08

(52) U.S. Cl. 340/539.1; 340/665

(57) ABSTRACT

An apparatus includes a hardened case configured to be removably coupled to an object and at least one sensor configured to detect a movement, shock, or impact associated with the object. The apparatus also includes a control unit disposed within the hardened case and communicatively coupled to the at least one sensor. The control unit is configured to compare a value of the movement, shock, or impact to a threshold amount, and when the value of the movement, shock, or impact exceeds the threshold amount, transmit information associated with the movement, shock, or impact to an external device.

### TECHNICAL FIELD

This disclosure relates generally to tracking systems and, more specifically, to an apparatus and method for shock or impact detection in the movement of cargo, operation of equipment, and other environments.

### BACKGROUND

Detection of damage is an important concern for those who transport, deliver, or operate goods and equipment. For example, many products are transported in containers like tanks, boxes, and pallets. Although many containers are tracked at certain points along a supply chain, full visibility into a supply chain is often limited. For example, whether or not a product or container has been damaged during transport is often unknown. The materials and products in the containers may be very valuable or expensive, or may include hazardous materials or other materials that have regulatory requirements. Likewise, during operation of certain equipment, some movements (such as a shock or impact) may be significant enough to cause damage to the equipment. However, such movements, shock, or impact may be difficult for a human operator to detect by sight, sound, or feel.

In many cases, the owners or those who depend on the condition of the containers, contents, or equipment will not know if a damaging movement, impact or shock has occurred to the equipment. For example, in the case of electrical equipment or downhole tools being transported to an offshore oil and gas platform, damaging movements, shocks and impacts often occur during the loading and unloading of vessels and in transportation. The owners and operators of this equipment are often not present at the time these events occur. The containers and equipment often show no outward signs of damage but will fail at critical and costly times due to the damaging movements, impacts or shocks.

### SUMMARY

This disclosure provides an apparatus and method for shock or impact detection in the movement of cargo, in the operation of equipment, and in other environments.

In a first embodiment, an apparatus includes a hardened case configured to be removably coupled to an object and at least one sensor configured to detect a movement, shock, or impact associated with the object. The apparatus also includes a control unit disposed within the hardened case and communicatively coupled to the at least one sensor. The control unit is configured to compare a value of the movement, shock, or impact to a threshold amount, and when the value of the movement, shock, or impact exceeds the threshold amount, transmit information associated with the movement, shock, or impact to an external device.

In a second embodiment, a system includes a sensing device configured to couple to an object. The sensing device includes a hardened case configured to be removably coupled to the object, and at least one sensor configured to detect a movement, shock, or impact associated with the object. The sensing device also includes a control unit disposed within the hardened case and communicatively coupled to the at least one sensor. The control unit is configured to compare a value of the movement, shock, or impact to a threshold amount, and when the value of the movement, shock, or impact exceeds the threshold amount, transmit information associated with the movement, shock, or impact. The system also includes an external device configured to receive the transmitted information.

In a third embodiment, a method includes detecting, by a sensing device, a movement, shock, or impact associated with an object. The sensing device includes a hardened case configured to be removably coupled to the object, and at least one sensor configured to detect a movement, shock, or impact. The sensing device also includes a control unit disposed within the hardened case and communicatively coupled to the at least one sensor, the control unit configured to report information regarding the object. The method also includes comparing, by the sensing device, a value of the movement, shock, or impact to a threshold amount. The method further includes, when the value of the movement, shock, or impact exceeds the threshold amount, transmitting, by the sensing device, information associated with the movement, shock, or impact to an external device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates a conventional mobile tracker;

FIG. 2 illustrates an example global tracking device according to this disclosure;

FIG. 3 illustrates an example hardened case for a global tracking device according to this disclosure;

FIG. 4 illustrates an example bottom view of the hardened case according to this disclosure;

FIG. 5 illustrates an example cross-sectional view of the global tracking device according to this disclosure;

FIG. 6 illustrates an example circuit board in the global tracking device according to this disclosure;

FIG. 7 illustrates an example signal focusing configuration of the global tracking device according to this disclosure;

FIG. 8 illustrates an example global tracking and reporting system according to this disclosure; and

FIG. 9 illustrates an example method for detecting and reporting a movement, shock, or impact associated with an object according to this disclosure.

### DETAILED DESCRIPTION

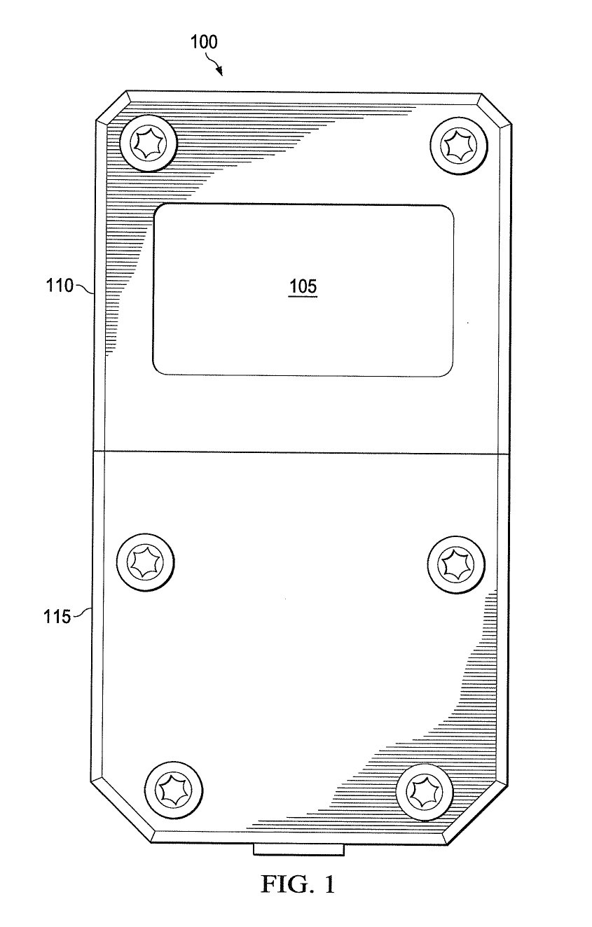

FIGS. 1 through 9, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates a conventional mobile tracker (MT) 100. The MT 100 is a wireless device that operates at 2.4 GHz Radio Frequency (RF) for programming of the MT 100. The MT 100 can be configured to enable an operator to extract data or change reporting parameters on the device or a group of devices using a wireless laptop or PDA handheld device. The MT 100 is configured to transmit data to a central facility via a satellite communication.

The MT 100 includes processing circuitry contained within a plastic housing 110. The MT 100 is configured to removably couple to an external battery pack 115. The battery pack 115 includes an energy storage source (such as a battery) contained within a plastic case.

In this example, the plastic housing 110 is not rugged, nor is it designed for harsh environments. Accordingly, the MT 100 may be susceptible to damage from extreme temperatures, shock (such as from falling or collisions), and weather. The plastic housing 110 can crack while in use or even prior to use, resulting in water entering into the plastic housing 110 and contaminating the processing circuitry 105.

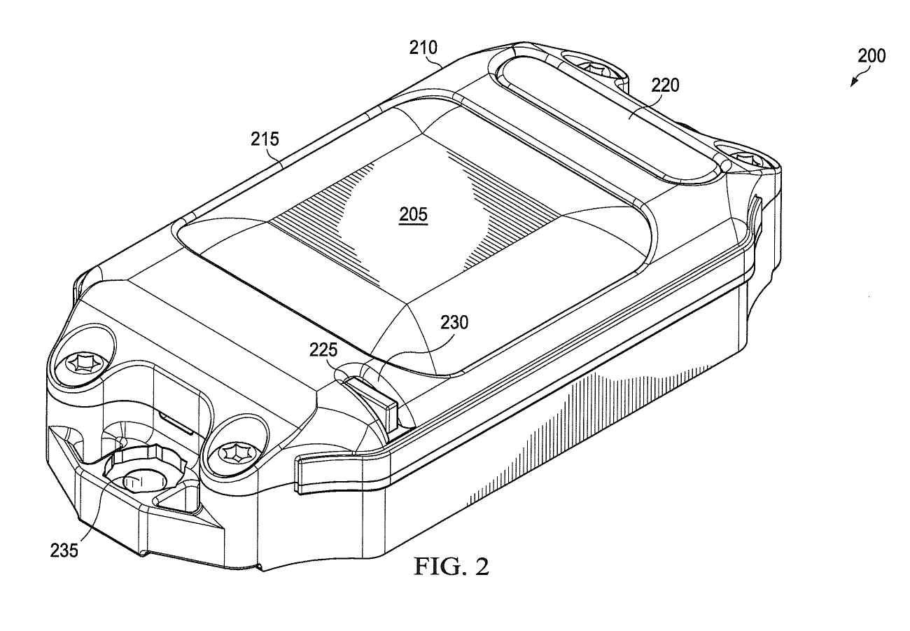

FIG. 2 illustrates an example global tracking device (GTD) 200 according to this disclosure. As shown in FIG. 2, the GTD 200 includes a control unit 205 and a hardened case 210. The hardened case 210 is configured to protect the control unit 205 during deployment in the field. The hardened case 210 can be formed from any suitable material(s), such as a zinc alloy, steel, or other suitable material. In some embodiments, the material used to form the hardened case 210 is anti-magnetic and/or non-sparking. The hardened case 210 inhibits damage to the control unit 205, such as by helping to prevent damage from compression, impact, and weather. As a specific example, the hardened case 210 can prevent water or other liquids from contacting or entering into the control unit 205. In some embodiments, the GTD 200 includes at least two layers of seals configured to protect processing circuitry and a power source contained within the control unit 205.

In this example, the hardened case 210 includes a first window 215 configured to allow transmission of wireless signals to and from the control unit 205. The wireless signals can include long-range RF signals, such as cellular wireless signals or satellite communication signals. The first window 215 is also configured to protect the control unit 205 from electro-static interference (ESI). In this example, the first window 215 is dimensioned to enable part of the control unit 205 to extend into the first window 215. In some embodiments, the portion of the control unit 205 that extends into the first window 215 can extend beyond a planar level of a surface of the hardened case 210. In addition, the first window 215 can be dimensioned to help focus wireless signals towards a transceiver in the control unit 205. For example, the first window 215 can be dimensioned so that a metal edge of the first window 215 is disposed at a specified angle in relation to a location of the transceiver. In some embodiments, the metal edge of the first window 215 is disposed at an angle of about 28° from the transceiver.

The hardened case 210 also includes a second window 220 configured to allow transmission of local wireless signals to and from the control unit 205. The local wireless signals can include BLUETOOTH, BLUETOOTH LOW ENERGY (BLE), WiFi, ZIGBEE, Radio Frequency identification (RFID), or other signals. The second window 220 also protects the control unit 205 from ESI. In this example, the second window 220 is dimensioned to enable part of the control unit 205 to extend into the second window 220. In some embodiments, the portion of the control unit 205 that extends into the second window 220 can extend beyond a planar level of a surface of the hardened case 210.

The GTD 200 further includes a switch 225 that enables an operator to activate or deactivate the GTD 200. The switch 225 here extends through a third window 230 in the hardened case 210. The switch 225 can be coupled to the processing circuitry or other components within the control unit 205. The switch 225 represents any suitable type of switch, such as a magnetic switch.

The GTD 200 is adapted to be removably mounted to a container or other structure. For example, the GTD 200 can include a mounting mechanism for attaching the GTD 200 to a number of different types of containers, tools, products, equipment, or machinery. For example, the GTD 200 can be mounted using one or more hex-head screws, socket-head cap screws, hex-head self-tapping screws, Phillips-head self tapping screws, stainless steel banding straps, zip-ties, VHB tape, and/or magnetic mountings. As a particular example, the hardened case 210 can include a number of openings 235 configured to receive screws, such as hex-head screws or socket-head cap screws. The GTD 200 can also be mounted via a standard mounting, a flush mounting, or some other mounting technique.

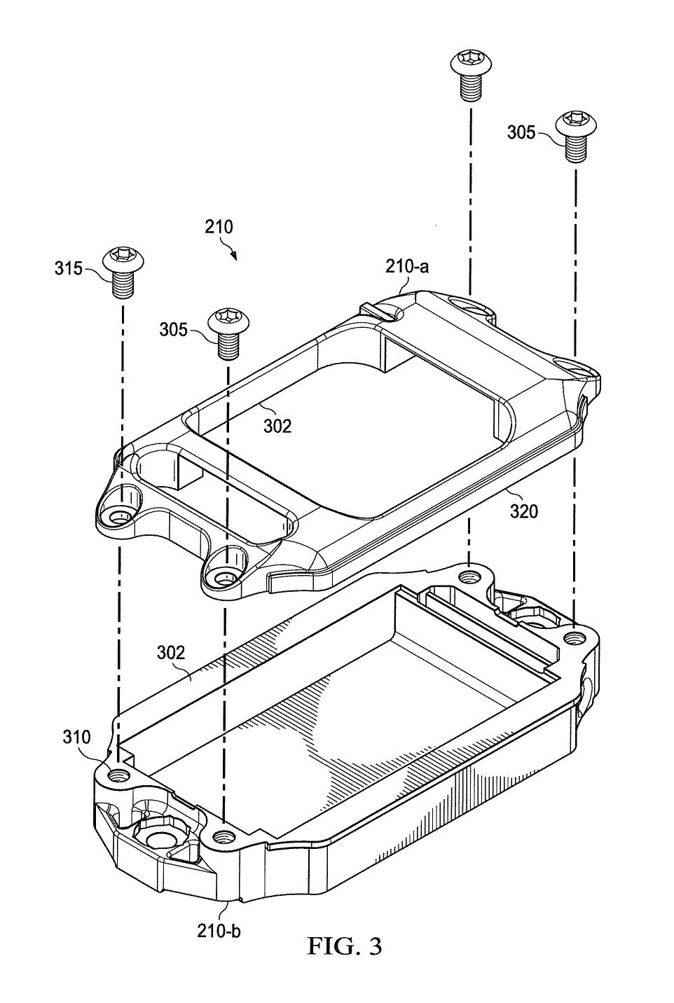

FIG. 3 illustrates an example hardened case 210 for a global tracking device 200 according to this disclosure. As shown in FIG. 3, the hardened case 210 is configured to protect processing circuitry in the control unit 205 and a power source for the processing circuitry. In some embodiments, the hardened case 210 and the processing circuitry in the control unit 205 can be configured to have a limited lump capacitance. Also, in some embodiments, the hardened case 210 is configured to be certified for powered devices operating within explosive environments. Example certifications could include European ATEX and/or International Electro-technical (IEC-W0029-0).

In the example shown in FIG. 3, the hardened case 210 has a modular construction. The hardened case 210 here includes a top portion 210-a and a bottom portion 210-b. When coupled together, the top portion 210-a and the bottom portion 210-b are configured to form a water-tight seal around the control unit 205. For example, the top portion 210-a and the bottom portion 210-b can include interlaced gaskets 302 each having multiple ridges configured to interlace with each other to form the water-tight seal. The gaskets 302 can include any suitable material(s) for forming a seal. The gaskets 302 could, for instance, be formed of a fluorosilicone material or other material(s) resistant to and providing a water-tight seal across a wide temperature range, such as from a low temperature of −40° C. to a high temperature of 85° C. The gaskets 302 can further be configured to absorb changes in section of metal or plastic.

In this example, the top portion 210-a also includes multiple support dowels 305, and the bottom portion 210-b also includes multiple vias 310. Each via 310 is adapted to receive and couple with a respective support dowel 305. Each via 310 can also include a threaded opening adapted to receive a connector, such as a hex bolt or other bolt 315. A bolt 315 can be inserted through an opening in one of the dowels 305 and coupled with the threaded opening in the via 310. Accordingly, the bolt 315 secures the top portion 210-a to the bottom portion 210-b. In some embodiments, the opening in one or more support dowels 305 is threaded. The support dowels 305 and vias 310 are configured to form an interlocking structure that protects against a shear load applied to the hardened case 210.

The hardened case 210 further includes reinforcement ridges 320 (also seen in FIG. 2). The reinforcement ridges 320 protrude from at least two sides of the hardened case 210. The reinforcement ridges 320 provide load bearing reinforcement to the hardened case 210. In some embodiments, the top portion 210-a includes one part of each reinforcement ridge 320, and the bottom portion 210-b includes another part of each reinforcement ridge 320. In other embodiments, either the top portion 210-a or the bottom portion 210-b includes each reinforcement ridge 320.

Different hardened cases 210 can be dimensioned to have different sizes depending upon specified applications. In some embodiments, one example of a hardened case 210 is dimensioned to be 3.1 inches wide, 6.25 inches long, and 1.41 inches high.

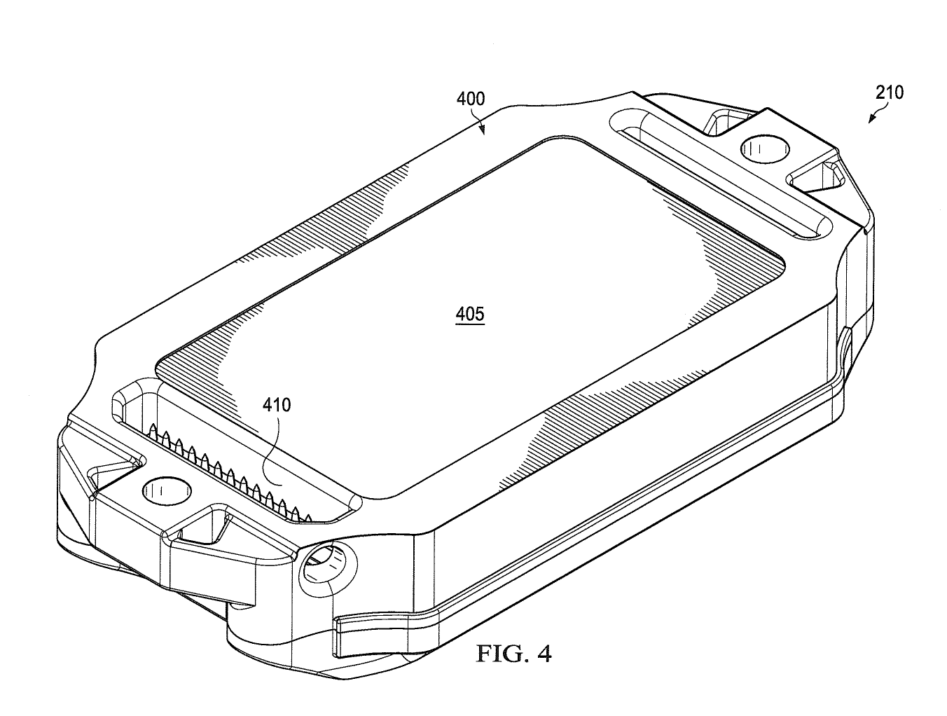

FIG. 4 illustrates an example bottom view of the hardened case 210 according to this disclosure. As shown in FIG. 4, the hardened case 210 includes a substantially flat mounting surface 400 (its bottom surface here). In some embodiments, the mounting surface 400 is flat and includes no protrusions or recesses. In other embodiments like the one shown here, the mounting surface 400 includes a recess 405. The recess 405 can be adapted, for example, to receive a mounting mechanism, such as a tape or magnetized source. The mounting surface 400 also includes a fourth window 410, which provides an access point to the control unit 205. For example, the fourth window 410 can be used to upgrade or connect to the control unit 205. The fourth window 410 includes one or more seals for inhibiting the leakage of liquids into the hardened case 210. Note that use of the fourth window 410 can be optional.

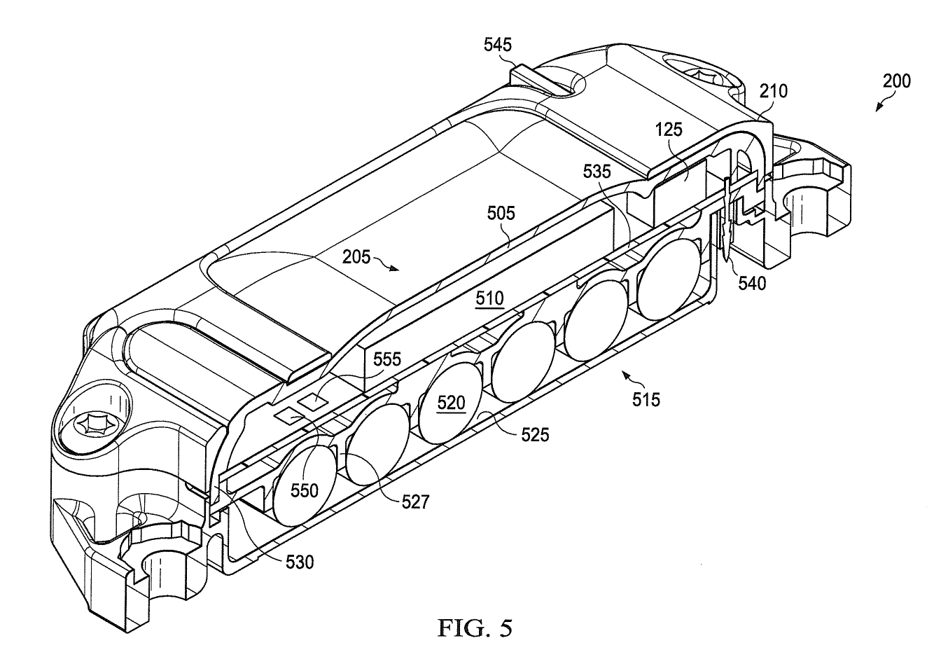

FIG. 5 illustrates an example cross-sectional view of the global tracking device 200 according to this disclosure. As shown in FIG. 5, the GTD 200 includes the control unit 205 protected by the hardened case 210. The control unit 205 here includes a plastic or other encasement 505. The encasement 505 can be molded to conform to an internal shape of the hardened case 210. In some embodiments, the encasement 505 is configured to form a water-tight seal with the internal surfaces of the hardened case 210. The encasement 505 can be a self-contained, sealed compartment that houses processing circuitry 510 and other components of the control unit 205. Accordingly, the combination of the hardened case 210 and the encasement 505 provides two layers of water-tight seals for the GTD 200. In some embodiments, portions of the encasement 505 are configured to extend through one or more windows 215, 220, 230 of the hardened case 210.

The GTD 200 also includes a power source 515, which supplies operating power for the GTD 200. Any suitable power source could be used, such as multiple batteries 520 coupled in series or in parallel. In some embodiments, the power source 515 can include a power converter configured to convert power from an external source for use by the processing circuitry 510 or other components. For example, the power source 515 can include a solar cell converter configured to convert or otherwise redirect electrical power generated by a solar cell into power configured to re-charge the batteries 520 and/or provide power to the processing circuitry 510.

In this example, the batteries 520 are contained within a battery compartment 525. The battery compartment 525 can be formed by a cavity created between the encasement 505 and the bottom portion 210-b of the hardened case 210. For example, the battery compartment 525 can be disposed in a region beneath or otherwise adjacent to a location of the processing circuitry 510 within the encasement 505. The encasement 505 can include a plurality of ribs 527 that are configured to define individual battery seats, as well as to inhibit compression of the control unit 250. Upon opening of the hardened case 210 (such as by removing the bottom portion 210-b), access to the batteries 520 within the battery compartment 525 can be obtained. Accordingly, one or more batteries 520 can be easily replaced by opening the hardened case 210.

The hardened case 210 further includes one or more seals 530 where different portions of the encasement 505 meet. Among other things, these seals 520 help to seal the battery compartment 525. This can also help to seal battery contacts electrically connecting the processing circuitry 510 to the batteries 520 in order to protect against liquids penetrating the control unit 205.

The processing circuitry 510 here is mounted on a circuit board 535, which is contained within the encasement 505. The circuit board 535 in this example includes an external electrical connection 540. The external electrical connection 540 is electrically coupled to the processing circuitry 510 through one or more connections on the circuit board 535. The external electrical connection 540 is also configured to extend through the fourth window 410. The external electrical connection 540 can be used in various ways, such as to communicate with or power the processing circuitry 510 or to couple to an external device. The junction of the external electrical connection 540 and the encasement 505 is configured to maintain the water-tight seal of the encasement 505. That is, the encasement 505 can be in physical contact with or otherwise molded to the external electrical connection 540 so that liquids cannot enter into the encasement 505 at the junction between the encasement 505 and external electrical connection 540.

The processing circuitry 510 is coupled to the switch 125 through one or more connections on the circuit board 535. The switch 125 can be configured, for example, to toggle the processing circuitry 510 from an on state to an off state and vice-versa. As a particular example, the switch 125 can be configured to interrupt or allow power from the power source 515 to be delivered to the processing circuitry 510. A portion 545 of the switch 125 extends through the third window 230 of the hardened case 210.

In addition, the GTD 200 includes transceivers 550-555 configured to communicate through one or more of the windows 215-220. As noted above, the transceivers 550-555 could support any suitable wireless communication protocol(s). For example, the transceiver 550 could represent a BLUETOOTH Low Energy (BLE) transceiver disposed in proximity to the second window 220, and the transceiver 555 could represent an RFID transceiver also disposed in proximity to the second window 220.

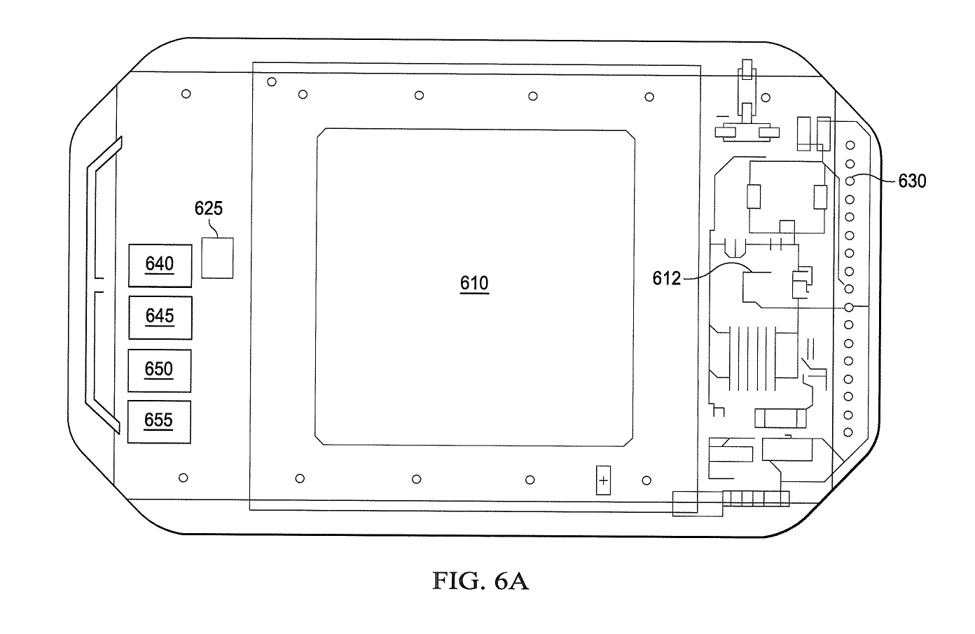

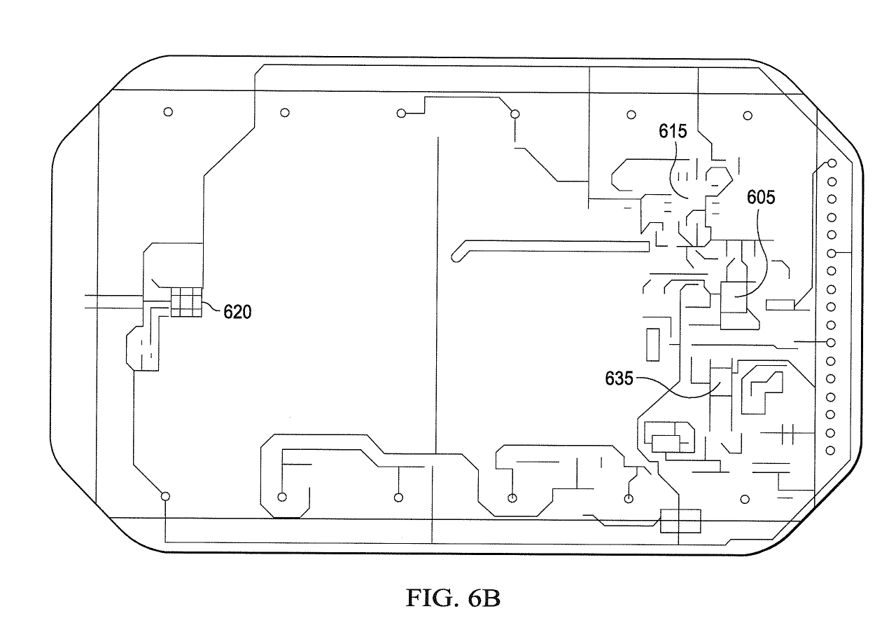

FIG. 6 illustrates an example circuit board 535 in the global tracking device 200 according to this disclosure. As shown in FIG. 6, circuitry is disposed on both sides of the circuit board 535. The circuitry here includes a controller 605 and a long-distance transceiver 610. The transceiver 610 can include an antenna coupled to a modem 612, such as a satellite modem, cellular modem, or other suitable wireless communications modem.

The circuitry also includes a global positioning system (GPS) engine 615, a BLE engine 620, and an RF identifier 625. The RF identifier 625 could be an embedded passive global RFID device. The circuit board 535 further includes various conductive tracings configured to communicatively couple the controller 605 to the transceiver 610, the GPS engine 615, the BLE engine 620 and the RF identifier 625. An expansion header 630 can be coupled to one or more elements on the circuit board 535 through the conductive tracings to provide a connection point for access to the components on the circuit board 535 or for future access. For example, the expansion header 630 can be configured to provide a future use capability for communicating with or powering of the processing circuitry 510 or for coupling to an external device.

The controller 605 is coupled to a memory 635. The memory 635 is configured to store instructions and data used, generated, or collected by the controller 605. The controller 605 is configured to control the functions of the GTD 200. For example, the controller 605 can be configured to control wireless communications sent and received by the transceiver 610 or the BLE engine 620.

The controller 605 may represent a single processing device, a multi-processing unit, or a distributed processing system. The controller 605 can utilize instructions stored in the memory 635 and connections to various other components, such as various transceivers, sensors, or batteries.

The memory 635 may include any suitable volatile and/or non-volatile storage and retrieval device(s). For example, the memory 635 can include any electronic, magnetic, electromagnetic, optical, electro-optical, electro-mechanical, and/or other physical device(s) that can contain, store, communicate, propagate, or transmit information. The memory 635 can store data and instructions for use by the controller 605. Additionally, the memory 635 can store information related to the object to which the GTD 200 is attached, such as detected location, event history, maintenance history, emergency handling procedures, and so forth.

External devices and users can interact with the GTD 200 in any suitable manner. For example, the GTD 200 could communicate with a monitor, keyboard, mouse, or other input/output device. The GTD 200 could also communicate wirelessly with other devices or systems.

In accordance with this disclosure, the circuit board 535 further includes multiple sensors. The sensors can include a shock sensor 640, an accelerometer 645, a temperature sensor 650, and a three-dimensional (3D) impact sensor 655. Either separately or in any combination, the shock sensor 640, accelerometer 645, and 3D impact sensor 655 are configured to detect and measure the magnitude and direction of movement, velocity, and acceleration in any direction in a three-dimensional space. As used herein, an impact or shock refers to a movement, force, acceleration, or deceleration in excess of a predetermined threshold. For example, an impact may refer to a force, acceleration, or deceleration equivalent to approximately three times the force of gravity (3G) in any direction. Each sensor 640-655 is adapted to transmit measurement information to the controller 605. In some embodiments, the sensors 640-655 can be combined or divided into additional or fewer sensors.

The controller 605 can use the sensors 640-655 in any suitable manner. For example, when the GTD 200 is attached to an object (e.g., a shipping container, package, equipment, and so forth), the controller 605 may use the sensors to determine if the object to which the GTD 200 is attached has been dropped or damaged. As a particular example, one or more of the sensors 640, 645, 655 can detect an impact involving the attached object. A large enough impact may cause damage to the object.

Due to the temporal and economic costs of damaged goods and equipment, it may be desirable to be notified of an impact (and potential damage) soon after the impact occurs. Accordingly, the GTD 200 can be configured to initiate event-based notification and maintenance. For instance, upon an occurrence of a movement over a threshold amount, such as an impact or shock, the GTD 200 can trigger an alarm or notification indicating that the object to which the GTD 200 is attached may require maintenance.

In some embodiments, the GTD 200 operates in an “always on” power state. In other embodiments, the GTD 200 is usually in a default “sleep” state or low-power state. In the sleep state, the GTD 200 may be able to detect movement or acceleration, including impact, but may be unable to transmit or receive signals. The GTD 200 remains in the sleep state until an impact or other movement over a predetermined threshold is detected. The sleep state allows the GTD 200 to minimize overall power usage and extend the life of the power source (e.g., the batteries 520).

Upon detection of an impact event, the GTD 200 “wakes” from the sleep state into a full operation state. When the GTD 200 wakes from the sleep state, the GTD 200 transmits information associated with the impact event to an external receiver. For example, the GTD 200 may wirelessly transmit the impact event information via the transceiver 610 over a satellite, cellular, or other suitable wireless communications network. The information may include the time, location, magnitude, and direction in x-y-z vectors (i.e., vectors associated with each of the three dimensions) of the impact event.

The controller 605 can be configured to differentiate between impact, movement, and machine vibration (such as vibration from normal operation). For example, each of impact, movement, and vibration may be associated with different predetermined thresholds or ranges of values. The predetermined thresholds or ranges may be configurable for different environments or different equipment. For example, a movement threshold for shipping or transporting may be different than a movement threshold for machine operation. Further, the sensitivity of each sensor 640-655 can be adjusted to suit current operating conditions or different equipment. For example, the sensors 640-655 could be configured to be more or less sensitive to detect or ignore very small vibrations. The controller 605 can combine information regarding motion and vibration to detect impact and differentiate impact from normal operation. The GTD 200 also can be configured to measure an internal temperature of the GTD 200.

During operation, the controller 605 can store data related to the object to which it is attached, including movement and impact information, in the memory 635. The controller 605 can therefore be configured to perform data logging, such as downloading high-resolution data locally. Additionally, the controller 605 can alter a timing of a report based on movement of the GTD 200, such as movement of the object to which the GTD 200 is attached. The GTD 200 can also store information related to vibration of the object to which the GTD 200 is attached. Accumulated vibration information can include data related to year-to-date, lifetime, and instant operation (this trip) vibrations. The GTD 200 can further measure the vibrations using the sensors and embed vibration information in messages reported to an operator or central facility. In some embodiments, the GTD 200 includes a vibration detection read switch configured to enable an operator to read vibration information via an external device.

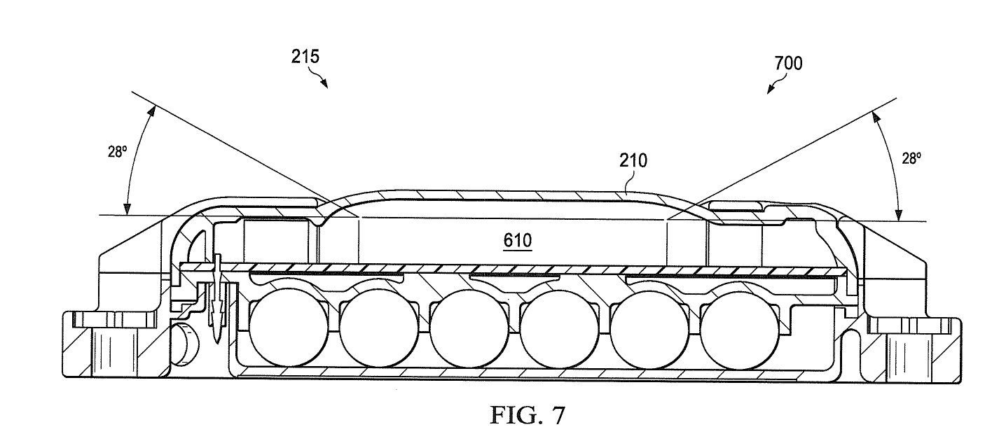

FIG. 7 illustrates an example signal focusing configuration 700 of the global tracking device 200 according to this disclosure. As shown in FIG. 7, one or more long-range RF signals are focused into the transceiver 610 using this signal focusing configuration.

The signal focusing configuration 700 defines a relationship between a location of the transceiver 610 and edges of the hardened case 210. More specifically, the transceiver 610 is disposed at a location corresponding to the first window 215. For example, the transceiver 610 can be disposed at a location on the circuit board 535 that is centered beneath the first window 215. The transceiver 610 is also disposed such that an angle formed by an adjacent edge of the first window 215, the transceiver 610, and the circuit board 535 focuses RF energy towards the transceiver 610. In some embodiments, the angle formed by an adjacent edge of the first window 215, the transceiver 610, and the circuit board 535 is about 28°. The hardened case 210 therefore focuses RF energy towards the transceiver 610. The exact position of the transceiver 610 may vary as long as the relationship between the transceiver 610 and edges of the first window 215 is maintained.

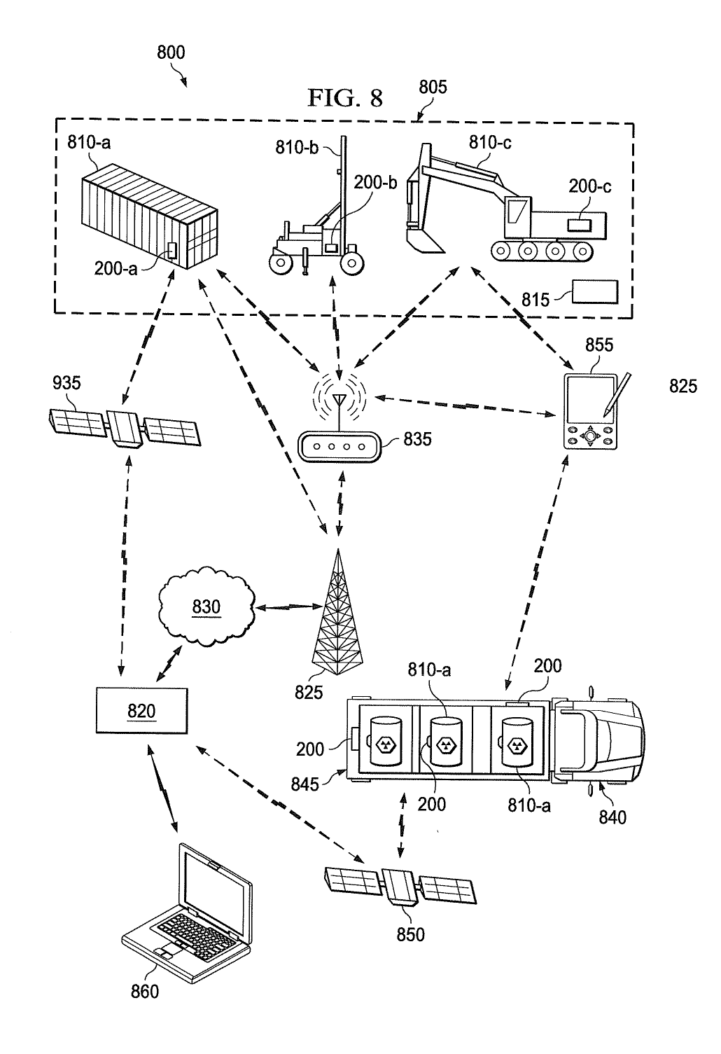

FIG. 8 illustrates an example global tracking and reporting system 800 according to this disclosure. As shown in FIG. 8, an operation site 805 includes multiple pieces of equipment 810, such as storage containers 810-a, machinery 810-b, and construction equipment 810-c. The operation site 805 can represent any suitable location, such as an excavation site, a drilling site, an industrial facility, a manufacturing site, or the like. The operation site 805 can include any number of pieces of equipment.

Each piece of equipment here includes, is attached to, or is otherwise associated with a GTD 200. For example, a container 810-a is associated with a first GTD 200-a attached to a sidewall, either internally or externally. Among other things, the first GTD 200-a could store information about the container 810-a and one or more articles contained within the container 810-a. Additionally, the machinery 810-b and the construction equipment 810-c are associated with a second GTD 200-b and a third GTD 200-c, respectively. Each of these GTDs 200-b and 200-c can store information regarding the respective item to which it is attached.

The operation site 805 can optionally include a transponder 815, such as an RFID transponder. The transponder 815 can be configured to transmit a location identifier (ID), read an identifier from an RFID transmitter, or both. The location identifier can include information regarding the operation site 805. For example, the GTD 200-a attached to the container 810-a can receive a location identifier from the transponder 815 as the GTD 200-a enters into communication proximity with the transponder 815. This could occur, for instance, when a transport truck delivers the container 810-a to the operation site 805 and the transponder 815 transmits the location identifier to the GTD 200-a. The first GTD 200-a can then transmit a message to a central facility 820. The message can include the location identifier and a container ID. In some embodiments, the message also includes information regarding the contents of the container 810-a. For example, the message may indicate that a specified container is located at a specified operation and contains specified equipment and material. If the GTD 200 is configured to do so, the message can also include an identifier uniquely associated with the contents of the container 810-a. In some embodiments, when the contents include a radioactive or other hazardous source, the message can include a reading from a radiation sensor or other sensor (in either the container 810-a or operation site 805). The GTDs 200-b and 200-c can also transmit messages to the central facility 820 about their associated machinery 810-b and construction equipment 810-c. Additionally, if a GTD is so configured, a message can include an identifier of other co-located GTD-enabled objects nearby.

In some embodiments, messages from the GTDs to the central facility 820 are transmitted using wireless cellular communications via one or more base stations 825 to the central facility 820. A base station 825 can be configured to transmit the messages to the central facility 820 via wireless communications or via a backhaul connection 830.

In other embodiments, messages can also be transmitted to one or more relay stations 835. A relay station 835 may be located at a regional office with a transceiver, or the relay station may be a standalone transceiver with appropriate logic necessary to transmit the messages.

In yet other embodiments, a vehicle 840 can transport equipment or materials, such as in one or more containers 810-a. The vehicle 840 could represent a truck, railcar, ship, plane, or other vehicle. The containers 810-a on the vehicle 840 are housed in an overpack 845, such as when the containers 810-a contain a radioactive material. The containers 810-a include a number of articles with corresponding information, such as IDs, stored in the memory of the attached GTDs 200. In some embodiments, the GTDs 200 on the containers 810-a transmit messages to the central facility 820 via one or more satellites 850. The overpack 845 can also transmit an overpack message, which includes information received from the GTDs 200 attached to the containers 810-a, to the central facility 820 via the satellite(s) 850. A transceiver on the vehicle 840 can further transmit messages or overpack messages to the central facility via the satellite(s) 850. Note, however, that the messages from the vehicle 840 can be sent in other ways, such as via the base station(s) 825 or relay station(s) 835.

In FIG. 8, at least one portable external device 855 is configured to communicate with various GTDs. The external device 855 can be any type of portable device adapted to transmit data to and receive data from one or more GTDs. The external device 855 could, for example, represent a cellular phone, a smartphone, a personal digital assistance, or a laptop computer.

In some embodiments, the external device 855 is adapted to query a GTD to obtain information about the object to which the GTD is attached, such as the container 810-a, machinery 810-b, or construction equipment 810-c. The external device 855 can also be adapted to program the GTD. For example, the external device 855 can be configured to allow a user to establish a periodic interval for reporting, upload or download maintenance history and comments, and upload or download emergency handling procedures.

The central facility 820 is configured to receive messages and overpack messages from the GTDs and other components at multiple locations. The central facility 820 can also be adapted to track the locations of each GTD, and as such the object to which each GTD 200 is attached, in a database. The central facility 820 can further be configured to report the locations, movement, and histories of each piece of equipment via a user interface 860, such as a computer terminal or website.

In some embodiments, the central facility 820 can generate information data records regarding the locations, movement, and histories of the equipment. For example, the central facility 820 can support a website located on a global communication network (GCN) (such as the web). The website can include the information data records. Accordingly, one or multiple users can be provided access to the location, movement, and history of each piece of equipment. In some embodiments, the website includes a graphical representation of the locations of the pieces of equipment 810. Also, in some embodiments, the website is configured to allow users to interact with the graphical representations. For example, a user may be able to select an icon representing a particular piece of equipment, and in response the website displays information corresponding to the selected equipment.

In some embodiments, the central facility 820 is also configured to send email notifications to multiple users. For example, the central facility 820 can be configured to send the notifications in response to an “alert” event occurring, at periodic intervals, or both. As a particular example, if a container experiences a collision as reported by its GTD 200 and/or is moved (transported), the central facility 820 can send an email alert to a predetermined list of users informing them that the equipment is being moved and/or may be damaged.

As noted above, the GTD 200 can be used in a variety of environments, such as in the oil and gas industry, at excavation sites, or in the shipment or transport of goods and products. Specifically, the GTD 200 can be used to detect and report damaging vibrations, shocks, and impacts associated with objects to which the GTD 200 is attached.

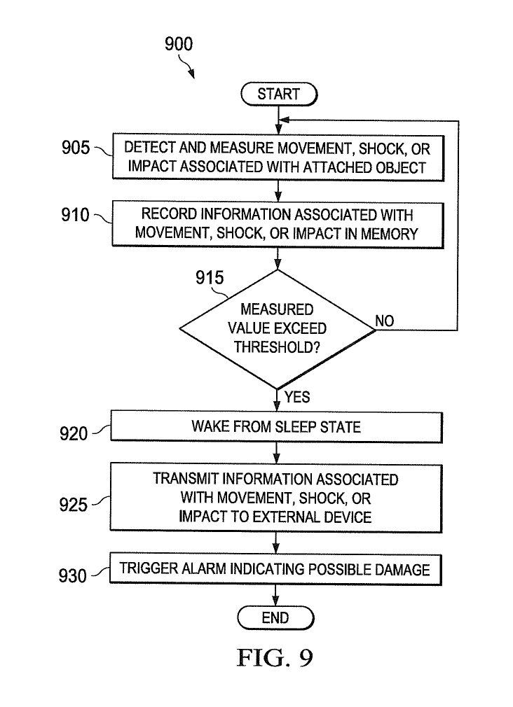

FIG. 9 illustrates an example method for detecting and reporting a movement, shock, or impact associated with an object according to this disclosure. In particular, FIG. 9 illustrates an example method performed by the GTD 200 or other sensing device.

As shown in FIG. 9, a method 900 includes a sensing device detecting and measuring a movement, shock, or impact associated with an object to which the sensing device is attached at step 905. The object may include, for example, a shipping container, a product or equipment being shipped or transported, or an equipment currently in operation. The sensing device records information associated with the movement, shock, or impact in a memory in step 910. The information may include, for example, a time, location, magnitude, or direction of the movement, shock, or impact. The information may be recorded, for example, in a log, table, or database in an internal memory of the sensing device.

At step 915, the sensing device compares a measured value of the movement, shock, or impact to a threshold value. The threshold value may be configurable for different environments. For example, the threshold value may be approximately three times the force of gravity. If the measured value of the movement, shock, or impact does not exceed the threshold value, then the sensing device resumes a default operation, which may include operating in a low-power sleep state.

Alternatively, if the measured value of the movement, shock, or impact exceeds the threshold value, then the sensing device wakes from the sleep state into a full operation state at step 920. The sensing device transmits information associated with the movement, shock, or impact to an external device at step 925. For example, the sensing device may transmit the information to the external device over a satellite or cellular network. The external device may include a portable handheld device or a central operations facility. The sensing device may also trigger an alarm or notification at step 930. The alarm or notification indicates that possible damage may have occurred to the object due to the movement, shock, or impact over the threshold amount. The alarm or notification may be received at the external device.

Although various features have been shown in FIGS. 2 through 8 and described above, various changes may be made to these figures. For example, the size, shape, arrangement, and layout of components shown in FIGS. 2 through 8 are for illustration only. Each component could have any suitable size, shape, and dimensions, and multiple components could have any suitable arrangement and layout. Also, various components in FIGS. 2 through 8 could be combined, further subdivided, or omitted and additional components could be added according to particular needs. For instance, a system using GTDs could support only cellular or satellite communications. Further, each component in a device or system could be implemented using any suitable structure(s) for performing the described function(s). In addition, while FIG. 9 illustrates various series of steps, various steps in FIG. 9 could overlap, occur in parallel, occur multiple times, or occur in a different order.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a hardened case configured to be removably coupled to an object;
at least one sensor configured to detect a movement, shock, or impact associated with the object; and
a control unit disposed within the hardened case and communicatively coupled to the at least one sensor, the control unit configured to:
compare a value of the movement, shock, or impact to a threshold amount; and
when the value of the movement, shock, or impact exceeds the threshold amount, transmit information associated with the movement, shock, or impact to an external device.

2. The apparatus of claim 1, the control unit further configured to trigger an alarm or notification indicating possible damage to the object when the value of the movement, shock, or impact exceeds the threshold amount.

3. The apparatus of claim 1, wherein the threshold amount is approximately three times the force of gravity.

4. The apparatus of claim 1, wherein the object is one of a shipping container, a product in shipment, and an equipment.

5. The apparatus of claim 1, the control unit further configured to transmit the information associated with the movement, shock, or impact via a wireless network, the wireless network being one of a satellite network and a cellular network.

6. The apparatus of claim 1, the apparatus further comprising a memory communicatively coupled to the control unit, the control unit further configured to record the information associated with the movement, shock, or impact in the memory.

7. The apparatus of claim 1, wherein the movement, shock, or impact is associated with one of a shipment of the object and an operation of the object, and wherein the threshold amount is configurable depending on whether the movement, shock, or impact is associated with the shipment of the object or the operation of the object.

8. A system comprising:
a sensing device configured to couple to an object, the sensing device comprising:
a hardened case configured to be removably coupled to the object;
at least one sensor configured to detect a movement, shock, or impact associated with the object; and
a control unit disposed within the hardened case and communicatively coupled to the at least one sensor, the control unit configured to compare a value of the movement, shock, or impact to a threshold amount, and when the value of the movement, shock, or impact exceeds the threshold amount, transmit information associated with the movement, shock, or impact; and
an external device configured to receive the transmitted information.

9. The system of claim 8, the control unit further configured to trigger an alarm or notification indicating possible damage to the object when the value of the movement, shock, or impact exceeds the threshold amount.

10. The system of claim 8, wherein the threshold amount is approximately three times the force of gravity.

11. The system of claim 8, wherein the object is one of a shipping container, a product in shipment, and an equipment.

12. The system of claim 8, the control unit further configured to transmit the information associated with the movement, shock, or impact via a wireless network, the wireless network being one of a satellite network and a cellular network.

13. The system of claim 12, the sensing device further comprising a memory communicatively coupled to the control unit, the control unit further configured to record the information associated with the movement, shock, or impact in the memory.

14. The system of claim 8, wherein the movement, shock, or impact is associated with one of a shipment of the object and an operation of the object, and wherein the threshold amount is configurable depending on whether the movement, shock, or impact is associated with the shipment of the object or the operation of the object.

15. The system of claim 8, wherein the external device comprises one of: a portable handheld device and a central computing facility.

16. A method comprising:
detecting, by a sensing device, a movement, shock, or impact associated with an object, wherein the sensing device comprises:
a hardened case configured to be removably coupled to the object;
at least one sensor configured to detect a movement, shock, or impact; and
a control unit disposed within the hardened case and communicatively coupled to the at least one sensor, the control unit configured to report information regarding the object;
comparing, by the sensing device, a value of the movement, shock, or impact to a threshold amount; and
when the value of the movement, shock, or impact exceeds the threshold amount, transmitting, by the sensing device, information associated with the movement, shock, or impact to an external device.

17. The method of claim 16, further comprising:
triggering, by the sensing device, an alarm or notification indicating possible damage to the object when the value of the movement, shock, or impact exceeds the threshold amount.

18. The method of claim 16, wherein the threshold amount is approximately three times the force of gravity.

19. The method of claim 16, wherein the object is one of a shipping container, a product in shipment, and an equipment.

20. The method of claim 16, wherein the transmitting comprises transmitting the information associated with the movement, shock, or impact via a wireless network, the wireless network being one of a satellite network and a cellular network.
